(19) United States
(12) Patent Application Publication
(10) Pub. No.: US 2024/0425651 A1
(43) Pub. Date: Dec. 26, 2024

(54) LIGNIN, METHODS OF EXTRACTION AND USES THEREOF

(71) Applicants: UNIVERSIDADE CATÓLICA PORTUGUESA - UCP, Porto (PT); AMYRIS BIO PRODUCTS PORTUGAL UNIPESSOAL LDA, Porto (PT)

(72) Inventors: Patrícia Filipa SANTOS COSTA, Porto (PT); Maria Inês FERREIRA DA MOTA, Porto (PT); Filipa Alexandre SOARES GOMES ANTUNES, Porto (PT); Braian ESNEIDER BUITRAGO URIBE, Vila Nova De Gaia (PT); João Porfírio DA SILVA BURGAL, Porto (PT); Maria Manuela ESTEVES PINTADO, Porto (PT)

(73) Assignees: UNIVERSIDADE CATÓLICA PORTUGUESA - UCP, Porto (PT); AMYRIS BIO PRODUCTS PORTUGAL UNIPESSOAL LDA, Porto (PT)

(21) Appl. No.: 18/700,897

(22) PCT Filed: Oct. 12, 2022
(86) PCT No.: PCT/IB2022/059788

§ 371 Date: Apr. 12, 2024

(30) Foreign Application Priority Data
Oct. 12, 2021 (PT) 117514

(51) Int. Cl. C08H 7/00; C08L 97/00

(52) U.S. Cl. CPC C08H 6/00; C08L 97/005

(57) ABSTRACT

The present disclosure relates to a light-brown lignin, preferably alkaline lignin, with sweet and weak woody odour, and ultraviolet protection activity. The present disclosure also relates to an alkaline method of extracting said lignin from sugarcane bagasse using mild conditions, the lignin, preferably alkaline lignin, obtained by the method of the present disclosure also has a high purity. The lignin of the present disclosure may be used as thermoplastic and thermosetting, namely for the production of a film, a packaging, a coating.

### TECHNICAL FIELD

The present disclosure relates to a light-brown lignin, preferably alkaline lignin, with a sweet and woody odour, antioxidant activity, and ultraviolet protection for use in materials. The present disclosure also relates to an alkaline method of extracting said lignin from sugarcane bagasse (SCB) using mild conditions, the lignin obtained by the method of the present disclosure also has a high purity. The lignin of the present disclosure may be used as thermoplastic and thermosetting, namely for the production of a film, a packaging, a coating.

### BACKGROUND

Recent concerns about climatic change and the exploration of alternatives to fossil fuels has focused global attention on sugarcane as a source of biomass. The annual global production of sugarcane is about 328 Mt with Asia being the main production region (44%) followed by South America (34%) (Sindhu et al. 2016). The significance of the sugarcane industry is not only due to sugar production but also to its by-products. Sugar production from sugarcane generates several by-products that can be used for energy production. Although highly appealing for environmental and financial reasons, it still remains economically unattractive. In this context, the conversion of by-products into value added compounds and applications is crucial. The main solid by-products include plant tops, straw, bagasse, filter cake and molasses, which can be grouped into two stages: those originated during the harvesting stage (tops and straw), and those produced during industrial processing (bagasse, filter cake, and molasses). The main components of the solid by-products include cellulose, hemicellulose and lignin.

Sugarcane is a large perennial tropical grass belonging to the family Gramineae and the genus Saccharum officinarum. Sugarcane is a major crop cultivated globally for sugar production with relevant features as high biomass yield, high sucrose content and high efficiency in accumulating solar energy. After the harvest of sugarcane, the sugarcane stalks are processed in sugar mills for the extraction of cane juice, while the leaves and tops are left in the cane field. Two major by-products from the sugarcane industry are the harvest residue (straw) and the fibrous fraction following juice extraction (bagasse). These post-harvest by-products have been suggested as an abundant and inexpensive source of lignocellulosic biomass. Sugarcane bagasse (SCB) and sugarcane straw (SCS) are basically composed of cellulose, hemicellulose, and lignin, with lower amounts of extractives and ash. SCB is almost completely used by the sugar industry as fuel for the boilers, while SCS is commonly used as animal fodder or burnt in the field (Sindhu et al. 2016). Lignocellulosic biomass has been recognized for its potential use to produce chemicals and materials, having the advantages of low cost and availability.

Researches have been conducted in exploring isolation methods and potential applications. These wastes streams, SCB and SCS, may constitute a lignocellulosic source in countries with high sugarcane production such as Brazil, India and China (Sindhu et al. 2016). Both SCB and SCS have a high cellulose (30-40 wt. %) content, which could be used to produce Second Generation (2G) ethanol via different chemical, physical or biological pre-treatments to convert them into fermentable sugars, while separating and valorising lignin as well. Another positive aspect of sugarcane is that it is not required an increase in the harvesting area because this residue has a high regeneration capacity and yield (80 t/ha), thus not competing with arable land.

Lignin is the second most abundant biopolymer in nature. Lignin is part of the cellular wall and confers structural support, hydrophobicity and resistance against microbial attack and oxidative stress, and among the components of lignocellulose, it is the most recalcitrant to chemical and biological degradation. The main functions attributed to lignin in the plant are elasticity and mechanical strength. Hemicellulose is linked to cellulose and lignin by covalent bonds and fewer hydrogen bonds. Lignin acts like a glue and bind cellulose and hemicellulose, which in turn makes the structure more moisture resistant and recalcitrant to chemical and biological degradation. Lignin is a complex aromatic macromolecule formed by the dehydrogenative polymerization of three phenylpropanoid monomers coniferyl, synapyl and p-coumaryl alcohols. In the specific case of sugarcane lignin, it is greatly acylated (p-coumaroylation) at their side chains, contain tricin flavonoid units and have ferulate residues cross-coupled between arabinoxylan and lignin (del Río et al. 2015).

The production of high-value lignin-derived products is still a challenge due to the complex structure of lignin, polydispersity, recalcitrant nature, dependence on the type of biomass, amongst others. Additionally, lignin isolation, fractionation, modification, and characterization remain a challenge. Usually, the pre-treatment process drives the separation of the lignocellulosic biomass into the main components as an efficient way of reducing natural recalcitrance of the lignocellulose cell wall (Liao et al. 2020). A suitable pre-treatment method aims to efficiently extract lignin from the lignocellulosic and generate a lignin fraction of high purity and quality that can achieve the requirements for subsequent conversion steps.

There is literature devoted to SCB deconstruction by hydrothermal, alkaline, acidic or organosolv pre-treatments and to different applications of the respective fractions, ranging from fuels (bioethanol), bioactive extractives (lipophilic or phenolic-rich extracts), high added value molecules and biomaterials. Lignin can be extracted using several methods such as alkaline, which include kraft and soda pulping, and aqueous alkaline pre-treatment; acidic, with organosolv and steam explosion pre-treatment and extraction; reductive catalytic fractionation; ionic liquid dissolution; and mechanical pre-treatment. After extracting lignin from the biomass, it is necessary to perform a separation and isolation step. Currently, the biggest supplier of lignin is the paper and pulp industry (in the form of black liquors), which utilizes an alkaline process (Arni 2018; Liao et al. 2020).

Traditionally, lignin is obtained from black liquor by precipitation methods, involving the use of acids, mostly with sulphuric acid, and more recently with a combination of carbon dioxide and sulfuric acid. At approximately pH 4, complete lignin precipitation has been observed by most researchers. It is well known that the ionization of phenolic groups plays a major role in the solubility of kraft lignin at alkaline pH. The apparent pKa value of lignin is a function of several parameters such as the chemical substitution pattern on the phenolic aromatic ring, temperature and solution conditions (Sewring et al. 2019).

Given the chemical structure of lignin and its high renewable source of aromatics, it can be used for the production of fuels and bulk chemicals, serving as an alternative for the petrochemical industry (Gillet et al. 2017). Many applications for lignin have been studied using it as a macromolecule for the development of materials with thermoplastic and thermosetting properties (Bajwa et al. 2019; Glasser 2019). From lignin deconstruction a wide range of thermoset polymers with different properties are obtained, for example, vinyl ester, cyanate ester, epoxy, phenolic and benzoxazine resins, with high mechanical resistance and thermostability. Regarding polymers with thermoplastic behaviour, some linear polyesters, polyanhydrides from ferulic acid, polyacetals, polycarbonates and poly oxalates are possible to be synthesized from lignin monomers (Llevot et al. 2016).

The structural characteristics of lignin depend on several factors including the botanical origin, environmental growth, and extraction conditions. A study with lignin from SCB extracted with different chemical procedures using ethanol and alkaline solutions was performed to evaluate their potential as antioxidant. Antioxidant activity of alkaline lignin was stronger than ethanol lignin due to its higher quantities of phenolic hydroxyl and methoxy groups that influenced more than its molecular mass and polydispersity (Li and Ge 2012).

Solar ultraviolet (UV) radiation is a causative factor of polymer and pigments degradation (Yousif and Haddad 2013). Several studies have shown the potential of lignin to prevent materials damage by blocking UV radiation (Sirvio et al. 2020). This property is associated with the ability of the phenolic groups to trigger radical scavenging (Widsten 2020). The hydrophobic nature of lignin is an interesting property for food packaging purposes, which includes films and coatings. Besides hydrophobicity, the ability to absorb UV-light, along with antioxidant and antimicrobial properties, are unique features for the development of films and coating materials.

Lignin is an attractive biopolymer due to its availability in nature, biodegradability, and thermo-mechanical properties. The chemical structure of lignin allows a variety of modifications that turns it into a potential building block for biopolymer synthesis, blends, and biocomposites. For example, when lignins are incorporated as fillers in natural polymers (e.g. Starch, polylactic acid, polyhydroxybutyrate), properties such as water absorption and mechanical performance have been improved. Because of the regular increase of glass transition temperatures in lignin-filled polymer systems, the use of plasticizers, which can eventually interact with the lignin, are used to reduce the intermolecular forces, increasing the flexibility and processability of the resulting materials (Yang et al. 2019).

The success of a coating relies on the compatibility between the polymer binder and fillers and their respective ratio in the coating formulation. Higher amounts of polymer usually improve gloss, scrub resistance and mechanical performance of coatings, however, it increases the coating cost. When fillers are in higher amount, the porosity and permeability of coatings increase. For biobased coatings the durability of phases to external environment is of utmost importance, thus the use of crosslinkers, modified fillers and the utilization of functional compounds that protect against corrosion or UV degradation are topics of technical relevance (Rastogi and Samyn 2015).

Coatings with modified lignin have demonstrated potential as barrier for oxygen and water vapor in paper-based substrates, for example, the esterification of lignin with tall oil fatty acids and independent saturated acids improved those properties for paper substrates when compared with unmodified lignin coatings or directly with pristine paper surfaces (Hult et al. 2013). Other interesting approach presents lignin as a functional compound to prevent corrosion of steels from electrochemical impedance measurements.

The typical dark colour of lignin is also a known constrain that limits its use in several applications that affects the final colour of the product. Since the early 1980s, research efforts have been made to understand the main factors responsible for attributing colour to lignin and/or develop methodologies to reduce its colour. It is assumed that coloured groups arise from chromophores and leucochromophores formation coming from lignin and carbohydrates. Lignin-based chromophores contain carbonyl functional groups, conjugated phenolics, quinoid structures and metal complexes. Some chromophores and leucochromophores originated from lignin include several quinones, catechol, among others.

Research studies indicate that besides the biomass source, unit operations involved in lignin production such as delignification, precipitation, recovery, and fractionation processes also have impact on colour since they are responsible for the formation or elimination of multiple-bond functional groups. Mild delignification conditions and lignin re-slurrying in acidic water usually result in brighter lignins. Suggested methodologies to reduce lignin colour submit lignin to chemical (e.g. oxidation or solvent fractionation) or biological (e.g. with fungi) processes. Nevertheless, these suggested processes are not yet cost-effective.

Typical strong lignin odour is usually attributed to small molecules originated from lignin itself (e.g. guaiacol) or delignification process (e.g. dimethyl disulphide) (Guggenberger et al. 2019). Guaiacol is one of the low-molecular weight compounds responsible for the typical smoky and woody odour of lignins.

These facts are disclosed to illustrate the technical problem addressed by the present disclosure.

### REFERENCES

1) Arni, Saleh Al. 2018. “Extraction and Isolation Methods for Lignin Separation from Sugarcane Bagasse: A Review.” Industrial Crops and Products 115:330-39.
2) Bajwa, D. S., G. Pourhashem, A. H. Ullah, and S. G. Bajwa. 2019. “A Concise Review of Current Lignin Production, Applications, Products and Their Environment Impact.” Industrial Crops and Products 139.
3) Canilha, Larissa, Victor T. O. Santos, George J. M. Rocha, João B. Almeida e Silva, Marco Giulietti, Silvio S. Silva, Maria G. A. Felipe, André Ferraz, Adriane M. F. Milagres, and Walter Carvalho. 2011. “A Study on the Pretreatment of a Sugarcane Bagasse Sample with Dilute Sulfuric Acid.” Journal of Industrial Microbiology & Biotechnology 38 (9): 1467-75.
4) da Silva, Ayla Sant′Ana, Hiroyuki Inoue, Takashi Endo, Shinichi Yano, and Elba P. S. Bon. 2010. “Milling Pretreatment of Sugarcane Bagasse and Straw for Enzymatic Hydrolysis and Ethanol Fermentation.” Bioresource Technology 101 (19): 7402-9.
5) del Río, José C., Alessandro G. Lino, Jorge L. Colodette, Claudio F. Lima, Ana Gutiérrez, Ángel T. Martinez, Fachuang Lu, John Ralph, and Jorge Rencoret. 2015. “Differences in the Chemical Structure of the Lignins from Sugarcane Bagasse and Straw.” Biomass and Bioenergy 81:322-38.
6) Gillet, S., M. Aguedo, L. Petitjean, A. R. C. Morais, A. M. da Costa Lopes, R. M. Łukasik, and P. T. Anastas. 2017. “Lignin Transformations for High Value Applications: Towards Targeted Modifications Using Green Chemistry.” Green Chemistry 19 (18): 4200-4233.
7) Glasser, Wolfgang G. 2019. “About Making Lignin Great Again-Some Lessons From the Past.” Frontiers in Chemistry 7 (August): 1-17.
8) Guggenberger, Matthias, Antje Potthast, Thomas Rosenau, and Stefan Böhmdorfer. 2019. “Quantification of Volatiles from Technical Lignins by Multiple Headspace Sampling-Solid-Phase Microextraction-Gas Chromatography-Mass Spectrometry.” ACS Sustainable Chemistry & Engineering 7 (11): 9896-9903.
9) Hult, Eva-Lena, Jarmo Ropponen, Kristiina Poppius-Levlin, Taina Ohra-Aho, and Tarja Tamminen. 2013. “Enhancing the Barrier Properties of Paper Board by a Novel Lignin Coating.” Industrial Crops and Products 50:694-700.
10) Li, Zhili and Yuanyuan Ge. 2012. “Antioxidant Activities of Lignin Extracted from Sugarcane Bagasse via Different Chemical Procedures.” International Journal of Biological Macromolecules 51 (5): 1116-20.
11) Liao, Jing Jing, Nur Hanis Abd Latif, Djalal Trache, Nicolas Brosse, and M. Hazwan Hussin. 2020. “Current Advancement on the Isolation, Characterization and Application of Lignin.” International Journal of Biological Macromolecules 162:985-1024.
12) Llevot, Audrey, Etienne Grau, Stéphane Carlotti, Stéphane Grelier, and Henri Cramail. 2016. “From Lignin-Derived Aromatic Compounds to Novel Biobased Polymers.” Macromolecular Rapid Communications 37 (1): 9-28.
13) Rabelo, S. C., H. Carrere, R. Maciel Filho, and A. C. Costa. 2011. “Production of Bioethanol, Methane and Heat from Sugarcane Bagasse in a Biorefinery Concept.” Bioresource Technology 102 (17): 7887-95.
14) Rastogi, Vibhore K. and Pieter Samyn. 2015. “Bio-Based Coatings for Paper Applications.” Coatings 5 (4).
15) Rocha, G. J. M., A. R. Gonçalves, B. R. Oliveira, E. G. Olivares, and C. E. V. Rossell. 2012. “Steam Explosion Pretreatment Reproduction and Alkaline Delignification Reactions Performed on a Pilot Scale with Sugarcane Bagasse for Bioethanol Production.” Industrial Crops and Products 35 (1): 274-79.
16) Sewring, Tor, Julie Durruty, Lynn Schneider, Helen Schneider, Tuve Mattsson, and Hans Theliander. 2019. “Acid Precipitation of Kraft Lignin from Aqueous Solutions: The Influence of PH, Temperature, and Xylan.” Journal of Wood Chemistry and Technology.
17) Sindhu, Raveendran, Edgard Gnansounou, Parameswaran Binod, and Ashok Pandey. 2016. “Bioconversion of Sugarcane Crop Residue for Value Added Products—An Overview.” Renewable Energy 98:203-15.
18) Sirvio, Juho Antti, Mostafa Y. Ismail, Kaitao Zhang, Mysore V. Tejesvi, and Ari Ämmälä. 2020. “Transparent Lignin-Containing Wood Nanofiber Films with UV-Blocking, Oxygen Barrier, and Anti-Microbial Properties.” Journal of Materials Chemistry A 8 (16): 7935-46.
19) Widsten, Petri. 2020. “Lignin-Based Sunscreens-State-of-the-Art, Prospects and Challenges.”
20) Yang, Jianlei, Yern Chee Ching, and Cheng Hock Chuah. 2019. “Applications of Lignocellulosic Fibers and Lignin In.” Polymers 11:1-26.
21) Yousif, Emad and Raghad Haddad. 2013. “Photodegradation and Photostabilization of Polymers, Especially Polystyrene: Review.” SpringerPlus 2 (1): 398.

### General Description

The present disclosure relates to a light-brown lignin, preferably alkaline lignin, with sweet and weak woody odour, and ultraviolet protection activity for use as thermosetting and thermoplastic. The present disclosure also relates to an alkaline method of extracting said lignin from SCB using mild conditions, the lignin obtained preferably alkaline lignin, by the method of the present disclosure also has a high purity.

Surprisingly, the method of the present disclosure produces an alkaline lignin with sweet and weak woody odour and lighter colour, the lignin of the present disclosure is obtained without the need for extra lignin-modification steps.

The typical dark colour of lignin is a challenge for its application such as in paints, resins, plastics, binders, composite materials. Biomass fractionation, lignin extraction and recovery involve formation and/or elimination of multiple-bond functional groups. In order to lighten colour of lignin, different solutions have been proposed including, for example, lignin fractionation using methanol/water solvent, irradiating lignin by UV irradiation in tetrahydrofuran solution, or by blocking the free phenolic hydroxyl of lignin and then self-assembling into colloidal spheres.

In view of the drawbacks to the prior art, the technical problem underlying the invention was to develop a new method for producing lignin. The lignin obtained by the method of the present disclosure has the advantage of being light brown coloured with a sweet and weak woody odour. It was surprisingly found that the alkaline lignin dried using spray dryer is lighter brown coloured as compared to the one dried using oven.

An aspect of the present disclosure relates to an alkaline lignin obtained by the method of the present disclosure comprising a sweet and woody odour, preferably with notes of paper and wooden pencil. In the state of the art, the lignin odour sensorial analysis was performed with a trained descriptive sensory panel of six individuals.

An aspect of the present disclosure relates to an alkaline lignin obtained by the method of the present disclosure comprising a light-brown colour, wherein the colour is at least to L*=45, a*=6, b*=16 scales, measured by the CIELAB system and wherein lignin has a sweet and woody odour, preferably with notes of paper wood and wooden pencil. In the state of the art, the colour may be measured by many methods, in the present disclosure the colour was measured by the CIELAB system (or CIE L+a+b+) system.

In an embodiment, these values are surprisingly obtained from residues from agriculture, better results were obtained using sugarcane bagasse.

In an embodiment for better results, the lignin is obtained by spray dryer.

In an embodiment, the lignin colour is at least to L*=60 measured by the CIELAB system, more preferably wherein the colour is at least to L*=70 measured by the CIELAB system. These values are achieved without any further bleaching step.

Surprisingly guaiacol is absent in the odour profile of the lignin of the present disclosure. This absence in combination with other factors may explain the sweet and woody odour, preferably with notes of paper wood and wooden pencil of the lignin of the present disclosure.

In an embodiment, the guaiacol is absent in the lignin odour profile of the lignin of the present disclosure. In an embodiment, in the lignin of the present disclosure guaiacol is absent (one of volatile organic compounds responsible for the strong smoky and woody odour of lignin). As shown in the FIGS. 5 and 6 the presence of guaiacol was not detected by HS-SPME-GC-MS for lignins of the present disclosure. Surprisingly, the lignin of the present disclosure has a light-brown coloured, sweet and weak woody odour, UV blocker and water resistant and allows the production of resistant coatings, film coating and materials namely a thermosetting material or a thermoplastic material.

In an embodiment, the colour is at least L*=60.3, a*=6.1, b*=19.1 for a lignin obtained by spray dried or L*=48.4, a*=10.0, b*=20.3 scales for a lignin obtained by oven dried; measured by CIELAB (or CIE L*a*b*) system.

In an embodiment, the alkaline lignin particle of the present disclosure size ranges from 0.3-280 μm measured by laser diffraction, preferably wherein 90% of the particle size are below 80 μm (Dv (90)); more preferably for dried lignin using a spray dryer the particle size below 57 μm (Dv (90)); or dried lignin using oven dried the particle size is below 78 μm (Dv (90)).

In the present disclosure, D10 (Dv (10)), D50 (Dv (50)), and D90 (Dv (90)), are called percentile values. These are statistical parameters that can be read directly from the cumulative particle size distribution. They indicate the size below which 10%, 50% or 90% of all particles are found.

In an embodiment, the lignin particle size ranges from 5-160 μm measured by laser diffraction, preferably the lignin particle size ranges from 5-40 μm.

In the state of the art, the particle size may be measured by many methods, in the present disclosure the particle size was measured by laser diffraction, preferably using the equipment Mastersizer™ 3000.

In an embodiment, the lignin comprises an ultraviolet light absorbance activity ranging from 2-12, measured at the global solar irradiance in the UV wavelength ranging from 290-400 nm.

In an embodiment, the functional groups of the alkaline lignin of the present disclosure may be selected from a list consisting of: carboxylic groups (1.08-1.23 mmol/g) and free phenolic hydroxyl groups (1.53-1.77 mmol/g).

In an embodiment, the lignin may comprise an improved antioxidant activity between 0.1-0.5 (mg/mL), preferably 0.2-0.3 (mg/mL), more preferably 0.20-0.27 (mg/ml).

In an embodiment, the lignin may comprise a glass transition temperature from 150 to 160° C.

Another aspect of the present disclosure relates to the use of the lignin of the present disclosure as a waterproofing agent, or a greaseproofing agent, or an ultraviolet blocking agent, or an antioxidant, or a pigment.

Another aspect of the present disclosure relates to a lignin composition comprising the lignin of the present disclosure at least one component of the following list: a hydroxyl precursor, a further polymer, a surfactant, or mixtures thereof.

In an embodiment, the lignin composition of the present disclosure is a coating composition, preferably a packaging coating composition, more preferably a paper/cardboard packaging coating composition, more preferably a food or a cosmetic paper/cardboard packaging.

In an embodiment, the hydroxyl precursor is a glycol; preferably ethylene glycol, a propylene glycol; glycerol, 1-4 butanediol, polyol, or mixtures thereof.

In an embodiment, the surfactant is polyethylene glycol sorbitan monolaurate (PEGSM) or sorbitane monooleate, or mixtures thereof.

In an embodiment, the composition further comprises ammonium hydroxide.

In an embodiment, the coating composition of the present disclosure may comprise 7 to 17 wt % of lignin; 9 to 20 wt % of glycol; 0 to 10 wt % of PEGSM; and ammonium hydroxide to complete 100 wt %.

In an embodiment, the material (thermosetting material or a thermoplastic material) of the present disclosure may further comprise at least one of the following components: a catalyst, a solvent, a filler, a crosslinker, or mixtures thereof.

In an embodiment, the material of the present disclosure may comprise
the catalyst is selected from a list consisting of: n-Butyl titanate, dibutyl tin dilaurate and stannous octoate, and mixtures thereof;
the solvent is ammonium hydroxide;
the filler is selected from a list consisting of: Lignin, cellulose, natural fibers, bagasse, wood powder, silica, calcium carbonate, aluminium trihydroxide, montmorillonites mineral fillers, and mixtures thereof;
the crosslinker is selected from a list consisting of: Lignin, citric acid, sebacic acid and itaconic acid, and mixtures thereof;
the hydroxyl precursor is selected from a list consisting of: Propylene glycol, glycerol, 1-4 butanediol, polyol, or mixtures thereof.

In an embodiment, the material described in the present disclosure may further comprise a polymer selected from the list of polycaprolactone; polyurethane, polyhydroxyalkanoates, polylactic acid, or mixture thereof; preferably polycaprolactone.

In an embodiment, the material of the present disclosure may comprise 50-93 wt % of caprolactone, 5-50 wt % of lignin, 0.1-3 wt % of a catalyst and 0-30 wt % of additives.

In an embodiment, the material of the present disclosure may further comprise at least a component of the following list: a catalyst, a solvent, a hydroxyl precursor, a wax, a crosslinker, or mixtures thereof.

In an embodiment, the material of the present disclosure may further comprise 1-50 wt % of the lignin composition, and polycaprolactone and/or process additives to complete 100 wt %.

In an embodiment, the material of the present disclosure may be a thermosetting material or a thermoplastic material.

In an embodiment, the material containing lignin in the present disclosure relate to thin films or packaging applications.

In an embodiment, the present disclosure relates to a method of preparing the lignin of the present disclosure from a SCB comprising the step of:
alkaline pre-treatment of SCB, preferably a soda (sodium hydroxide) pre-treatment, in order to obtain a black liquor;
acid precipitation of the black liquor obtained in the previous step and collect the precipitated to obtain a lignin;
drying the collected precipitate and optionally milling the dried lignin.

In an embodiment, in order to optimize lignin removal (i.e. delignification yield) from SCB, mild extracting temperature of between 80-120° C., preferably 90° C. and a liquid to solid ratio (v/wt) of 12-18 was used. The influence of extracting time (0.5 to 2 hours) and sodium hydroxide concentration (2-6 wt %) were also optimized.

In an embodiment, the precipitation agent is H₂SO₄, wherein the amount of H₂SO₄ ranges from 10-50% (v/wt), preferably from 20-35% (v/wt), more preferably 30% (v/wt).

In an embodiment, precipitation is performed at room temperature from 18-25° C., preferably from 20-22° C.

In an embodiment, the time of the precipitation stage ranges from 2-20 minutes, preferably from 5-10 minutes.

In an embodiment, in the precipitation stage, the H₂SO₄ is added in a flow rate ranging from 20-350 mL/min, preferably from 100-260 mL/min.

In an embodiment, the precipitation medium reaches a final temperature of 80-95° C.

In an embodiment, the drying is a spray drying or oven drying.

In an embodiment, the method may further comprise a filtration or a centrifugation step.

In an embodiment, the degree of purity of the obtained alkaline lignin is at least 85-90%, preferably more than 95%; more preferably more than 99%.

Another aspect of the present disclosure is the lignin obtained from the method of the present disclosure, a light-brown colour lignin from sugarcane bagasse, wherein the colour is at least L*=60.3, a*=6.1, b*=19.1 scales, measured by the CIELAB system, wherein guaiacol is absent in the lignin odour profile and wherein lignin has a sweet and woody odour. This lignin has better results when the alkaline pre-treatment is used and the lignin is from sugarcane bagasse.

### BRIEF DESCRIPTION OF THE DRAWINGS

The following figures provide preferred embodiments for illustrating the disclosure and should not be seen as limiting the scope of invention.

FIG. 1 shows an embodiment of the process of extracting lignin from lignin-rich sugarcane bagasse sample using oven.

FIG. 2 shows an embodiment of the process of extracting lignin from lignin-rich sugarcane bagasse sample using spray drying.

FIG. 3 shows photos of lignin-rich sample dried using an oven (FIG. 3A) and a spray dryer (FIG. 3B).

FIG. 4 shows the particle size distribution of the lignins.

FIG. 5 shows the HS-SPME-GC-MS chromatograms obtained in full scan for A) glycerol (solvent used to disperse lignins for analysis), B) commercial kraft lignin (CAS 8068 May 1), C) lignin produced herein, D) guaiacol standard and E) air (blank sample). HS-SPME-GC-MS was performed by a Bruker 456-GC gas chromatography equipped with a triple quadrupole mass spectral detector (mass range 33-450 m/z). Chromatographic separation was performed employing BR-5 MS column from Restek (USA, length 30 m, inner diameter 0.25 mm and film thickness 25 μm). Injector, transfer line and EI temperatures at 240° C., 280° C. and 230° C., respectively. Column temperature program: 40° C., 1 minute; 5° C./min up to 250° C., hold 5 minutes; 5° C./min up to 300° C. (58 minutes). It was employed a vdivinylbenzene/carboxen/polydimethylsiloxane (DVB/CAR/PDMS)·50/30 mm fiber from Supelco (Bellefonte, PA, USA). The incubation was performed at 40° C. for 10 minutes (500 rpm), the extraction at 40° C. for 30 minutes (500 rpm) and desorption during 10 min. SPME penetration depth of 16 mm.

FIG. 6 shows the HS-SPME-GC-MS extracted ion chromatograms at m/z 81 (for targeting guaiacol) obtained for A) glycerol (solvent used to disperse lignins for analysis), B) commercial kraft lignin, C) Lignin produced herein, D) guaiacol standard and E) air (blank sample). Analysis conditions are the same as described in FIG. 5. No guaiacol (RT 11.8 min) was detected in vials with air, glycerol and Spray dried lignin/glycerol).

FIG. 7 shows the dilution curve for the coating.

### DETAILED DESCRIPTION

The present disclosure relates to a light-brown alkaline lignin, with a sweet and weak woody odour, and ultraviolet protection for use in thermosetting and thermoplastics. The present disclosure also relates to an alkaline method of extracting said lignin from SCB using mild conditions.

Sugarcane composition can vary according to its origin and season of the year; however, it is possible to observe from data collected from June 2018 to August 2020 that the biomass received so far has a very homogeneous composition with similar cellulose content between 39 and 43% with slight variation in the content of hemicellulose of between 19 to 29%, lignin content of between 21 to 27% and inorganics content of between 1 to 4%. The data obtained is in accordance with that reported in literature: 39-45% of cellulose, 23-27% of hemicellulose, 19-32% of lignin, 5-7% of extractives and 1-3% inorganics (Canilha et al. 2011; Rabelo et al. 2011; Rocha et al. 2012; da Silva et al. 2010).

The reagents used in the extraction of lignin from SCB are displayed in Table 1 below.

TABLE 1
CAS number and purity of each reagent.

| | CAS | |
|---|---|---|
| Reagent | Number | Purity |
| Sodium hydroxide (NaOH) | 1310-73-2 | 100% |
| Sulfuric acid (H₂SO₄) | 7664-93-9 | 95-98% |

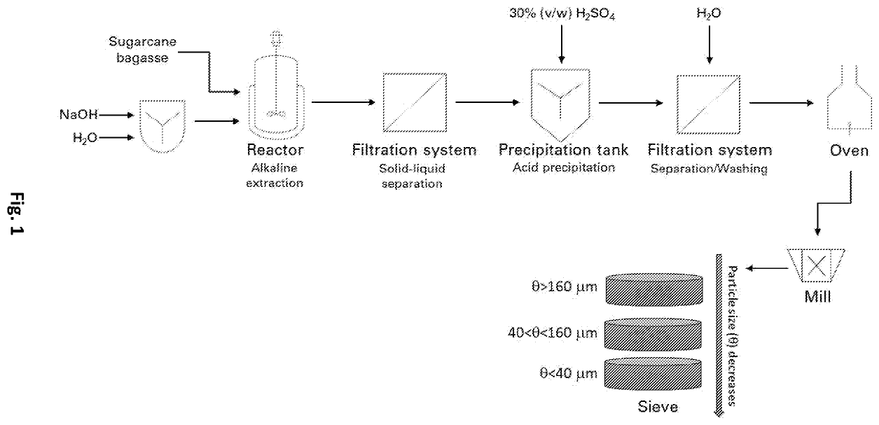

In an embodiment, lignin was extracted from SCB and oven dried. The extraction process of lignin of the present disclosure from SCB is as shown in FIG. 1. A brief description of the operating units is as follows:
STAGE 1:
Prepare alkaline solution by adding 2 wt % sodium hydroxide solution to deionized water in a mixer.
Delignification of SCB in a reactor (Parr Instrument Company Model 4848) using 2 wt % sodium hydroxide solution in deionized water.
STAGE 2:
Filtering out the extracted SCB biomass (solid) from the liquid stream containing the solubilized lignin (black liquor).
STAGE 3:
Precipitating out the lignin by gradual addition of 98 vol % sulfuric acid to the black liquor with stirring (200-500 rpm).
STAGE 4:
Filtering out the lignin solids from the acidified black liquor solution and thereafter wash the filtered lignin solids with deionized water.
STAGE 5:
Drying the filtered and washed lignin in an oven.
STAGE 6:
Grinding the oven dried lignin using ball milling method to reduce the lignin particle size.
STAGE 7:
Sieve the lignin powder using different meshes (315 μm, 160 μm, and 40 μm).

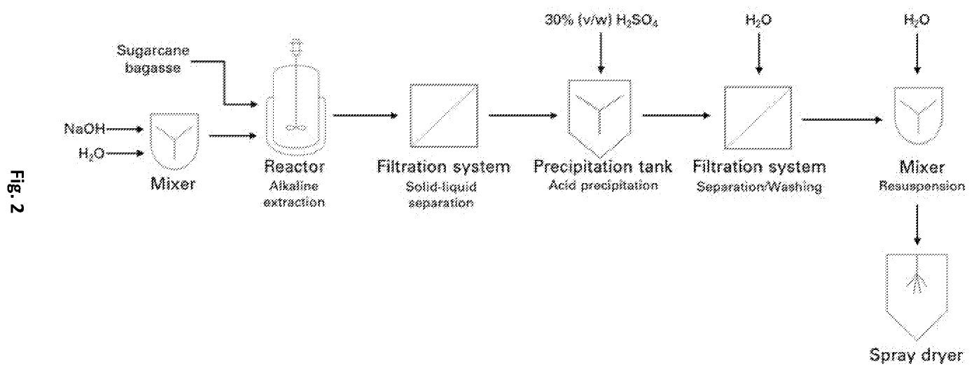

In an embodiment, the lignin of the present disclosure was extracted from SCB and dried using a spray dryer. For the process using the spray dryer, Steps 1˜4 are the same as described for the oven (FIG. 2). A brief description of the operating units is as follows:
STAGE 5:
Resuspend the filtered lignin (lignin cake) obtained in the preceding step in deionized water (cake moisture 74-83%).
STAGE 6:
Spray dry (Model Buchi Mini Spray Dryer B-290) the washed resuspended lignin, 5% solids (g dry lignin/g solution).

In an embodiment, the alkaline pre-treatment was performed using a mixer and a Parr reactor.

In an embodiment, the solvent preparation was performed as follows:
Prepare the solvent (2 wt % NaOH solution) by adding 30 g of NaOH to 1470 g of deionized water.

In an embodiment, the delignification reaction was performed as follows:
Weight 100 g of SCB for Parr reactor and add 1500 g of solvent (liquid-solid ratio of 15).
Perform the reaction for 0.5 hours (heating and cooling not considered) at 90° C.

In an embodiment, separation of alkaline black liquor (rich in lignin) from solid fraction (rich in cellulose and hemicellulose) was performed as follows:
Separate the black liquor and solid fraction from Stage 1 with a filtration system. On average, 1200 g of liquor (liquor density=1.01±0.01) is obtained.

In this step, on average, 74±2% of the lignin, 5±1% cellulose and 42±7% of hemicellulose initially available in the biomass, respectively, are solubilized in the extracting medium originating from the black liquor.

In an embodiment, precipitation of lignin was performed. Precipitation of lignin present in the alkaline black liquor was achieved by acidification with 30% (v/w) H₂SO₄ (98%).

In an embodiment, precipitation of lignin was performed as follows:
To each 1200 ml of black liquor, was added approximately 388 ml of H₂SO₄, corresponding to 30% (v/w), at a rate of 100-200 mL/min (the temperature reaches 90° C. at the end).
Afterwards, the mixture was maintained for one hour at room temperature before entering the next stage: Separation of lignin.

In an embodiment, separation of lignin by filtration or centrifugation, and washing was performed as follows:
Pour the content into a Büchner funnel (assembled in a filtration system) with a Whatman® qualitative filter paper, Grade 113, 24 cm (membrane area of about 452 cm²).
Add 20 L of tap water to the lignin to increase the pH of the lignin to a value of 6.5-7.

In an embodiment, the water content in the lignin is removed to obtain a powder. The water content is removed as follows:
Place the sample obtained in the previous stage (Stage 4) in an oven with forced convection at 40° C. for 16 hours.

In an embodiment, the particle size of the alkaline lignin particles of the present disclosure are reduced via ball milling as follows:
Transfer the dried lignin obtained in the previous stage (Stage 5) to the Ball Mill (Retsch PM100) (500 rpm, 1 hour).

In an embodiment, the alkaline lignin of the present disclosure is fractionated into different particle sizes as follows:
Transfer the dried lignin-rich samples obtained in the previous stage (Stage 5) to the Sieve (Retsch AS200 Basic).

In an embodiment, the alkaline lignin of the present disclosure is resuspended in deionized water before being dried by spray dryer as follows:
Mix the wet cake (moisture 72-84%) from Stage 4 with deionized water to obtain 5 wt % solids suspension and left under agitation (500 rpm) overnight (16 hours). Example: For 40.7 g of wet lignin cake (moisture 78%) add 141.4 g of deionized water.

In an embodiment, the alkaline lignin of the present disclosure is dried using a spray dryer to obtain a particle size below 57 μm (Dv (90)). Preferably, operate the spray dryer (Stage 6). Equipment operating conditions are: 65% aspirator rate, flow height 40-45 mm, pump speed 12%, inlet temperature 160° C.

In an embodiment, the alkaline lignin of the present disclosure is oven dried and, where particle size is below 78 μm (Dv (90)).

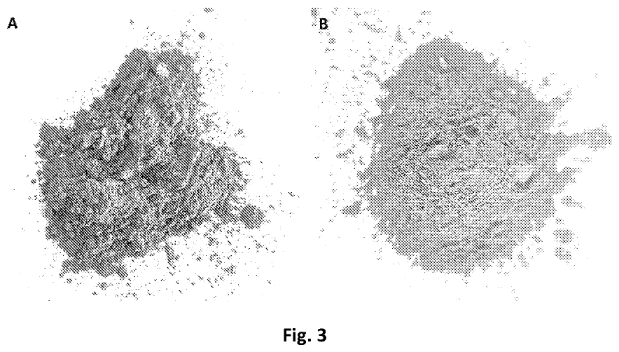

In an embodiment, the characteristics of the alkaline lignin of the present disclosure obtained from sugarcane using the two different drying techniques (oven and spray dryer) were evaluated and the results shown in Table 2 below. FIG. 3 shows the colour of each lignin.

TABLE 2
Physicochemical composition of lignin obtained using two drying
approaches (oven and spray dryer).

| | Lignin of the present disclosure | Lignin of the present disclosure |
|---|---|---|
| | (Spray dryer) | (Oven) |
| Raw material | Sugarcane bagasse | Sugarcane bagasse |
| Appearance (Colour, | Light-brown (L* = 60.3, a* = 6.1, b* = 19.1) | Light-brown (L* = 48.4, a* = 10.0, |
| CIELAB space colour) | | b* = 20.3) |
| Appearance (Form) | Powder | Powder |
| Odour | Sweet odour with notes of paper wood and | Sweet odour with notes of paper |
| | wooden pencil | wood and wooden pencil |
| Purity (wt %) | 91.9 ± 1.2 | 92.0 ± 0.4 |
| Sugars (wt %) | 2.00 ± 0.12 | 1.86 ± 0.03 |
| Cellulose (wt %) | 1.81 ± 0.13 | 1.73 ± 0.03 |
| Hemicellulose (wt %) | 0.22 ± 0.05 | 0.23 ± 0.03 |
| Ashes (wt %) | 2.2 ± 0.1 | 1.62 ± 0.001 |
| Solubility (mg/mL) | Acetone (4.3 ± 0.1); dimethyl sulfoxide (4.4 ± | Acetone (4.0 ± 0.6); dimethyl sulfoxide |
| | 0.3); methanol (4.2 ± 0.1); ethanol (3.4 ± 0.1); | (4.8 ± 1.2); in methanol (4.2 ± 0.3); |
| | Insoluble in water (0.7 ± 1.1 × 10⁻¹¹). | ethanol (3.7 ± 0.1); Insoluble in water |
| | | (0.7 ± 0.2) |
| Glass transition | 154 ± 3 | 155 ± 1 |
| temperature (° C.) | | |
| pH (5% in water) | 4.7 | 5.5 |

In an embodiment, the antioxidant activity of the alkaline lignin of the present disclosure was evaluated by Trolox Equivalent Antioxidant Capacity (TEAC) assay, and the results are presented in Table 3. The commercial antioxidant BHT were also tested as controls.

Table 3 below shows the antioxidant activity by Trolox equivalent antioxidant capacity (TEAC) method of alkaline lignin from sugarcane bagasse obtained using an oven and spray dryer. Butylated hydroxytoluene (BHT) was used as commercial antioxidant, and commercial lignin was used for comparison purposes (commercial alkali lignin, CAS 8068 May 1, with >95% purity acquired from Sigma-Aldrich) expressed in IC50 values (mg/mL)*.

TABLE 3
Antioxidant activity by Trolox equivalent antioxidant capacity (TEAC)
method of alkaline lignin from sugarcane bagasse oven and spray dried.

| Sample | IC50 (mg/ml) ^{δ} |
|---|---|
| Lignin of the present disclosure obtained by | 0.201 ± 0.006 |
| oven dried | |
| Lignin of the present disclosure obtained by | 0.270 ± 0.006 |
| spray dried | |
| Alkali lignin (CAS 8068-05-1) | 0.146 ± 0.001 |
| Butylated hydroxytoluene | 0.288 ± 0.007 |

^{δ} The IC50 values were given as the meantstandard deviation of at least three individual determinations each performed in triplicate.

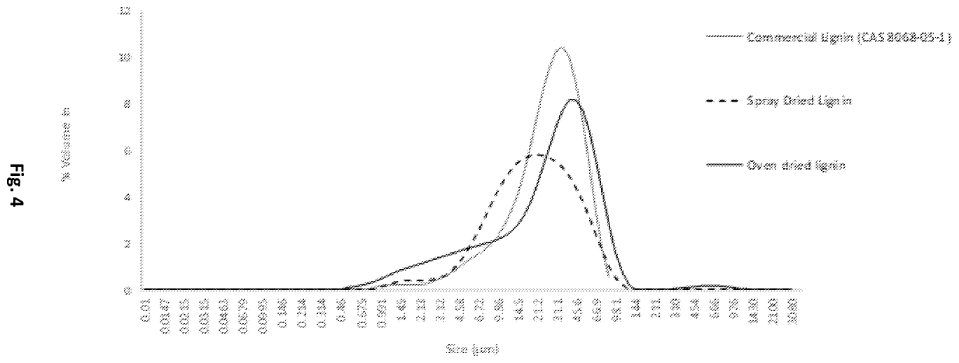

In an embodiment, the size of lignin particles was measured by laser diffraction (MasterSizer 3000 Malvern Instruments; Serial number MAL1125347). The solvent employed in the analysis and to disperse the sample was water (refractive index of 1.33). The background was set using water before each analysis. The sample was ultrasonicated externally for 5 minutes. The obscuration was set between 5-10%, 60-180 seconds of ultrasounds was applied before each measurement and stirring set to 3500 rpm. It was considered a particle refractive index of 1.64 and absorption index of 0.01. Data was analysed employing Mie scattering Model and general-purpose analysis model. Table 4 shows the standard percentiles Dv (10), Dv (50) and Dv (90). Particle size distribution is shown in Figure. 4.

TABLE 4
Lignins particle size distribution.

| | Drying | Appli- | Dv (10) | Dv (50) | Dv (90) |
|---|---|---|---|---|---|
| Sample | technique | cation | μm | μm | μm |
| Sugarcane | Spray | Ma- | 5.8-6.8 | 20.0-21.1 | 51.6-57.2 |
| bagasse lignin | dryer | terial*** | | | |
| of the present | Oven | Coatings | 1.9-4.2 | 22.8-33.4 | 71.9-78.1 |
| disclosure | | | | | |

| | | | | |
|---|---|---|---|---|
| Alkali lignin^{§} | — | — | 9.35-9.45 | 30.1-30.2 |

^{§}Commercial alkali Lignin, Sigma-Aldrich, CAS 8068-05-1
***thermosetting material or a thermoplastic material

TABLE 5
Free phenolic hydroxyl and carboxylic groups of lignins.

| | | | Free | Carboxylic |
|---|---|---|---|---|
| | Drying | Appli- | phenolic hydroxyl | groups** |
| Sample | technique | cation | groups* (mmol/g) | (mmol/g) |
| Sugarcane | Spray | Ma- | 1.75-1.77 | 1.23 |
| | dryer | terial*** | | |
| bagasse lignin | Oven | Coatings | 1.55 | 1.08 |
| of the present | | | | |
| disclosure | | | | |
| Commercial | — | — | 1.59-1.84 | 0.89 |
| lignin^{§} | | | | |

^{§}Commercial alkali lignin, Sigma-Aldrich, CAS 8068-05-1
*UV method
**Titration method
***thermosetting material or a thermoplastic material

In an embodiment, the lignin odour sensorial analysis was performed with a trained descriptive sensory panel of six individuals and results summarized in Table 6. The sensory evaluation was carried out blindly to minimize the perception bias and evaluation results were reported by consensus. The odour profile of the commercial alkali lignin (CAS 8068 May 1) (reference sample) was also evaluated by the sensory panel as representative of typical lignin odour. No odour descriptors listed for the commercial lignin (odour with notes of burnt wood, smoke, and spices) were identified in the lignin of the present disclosure. The SCB lignin produced herein had a much lower odour intensity than the commercial sample and the odour was described as weak, sweet with notes of paper, wood and wooden pencil (but not pine wood).

TABLE 6
Sensorial analysis performed by a trained descriptive sensory panel.

| Sample | Odour description |
|---|---|
| Commercial sample (Alkali Lignin, | Odour with notes of burnt wood, |
| Sigma-Aldrich, CAS 8068-05-1) | smoke and spices |
| Alkaline lignin of the present | Weak, sweet and woody odour with |
| disclosure | notes of paper wood and wooden |
| | pencil (but not pine wood) |
| | Notes of burnt wood, smoke and |
| | spices were absent |

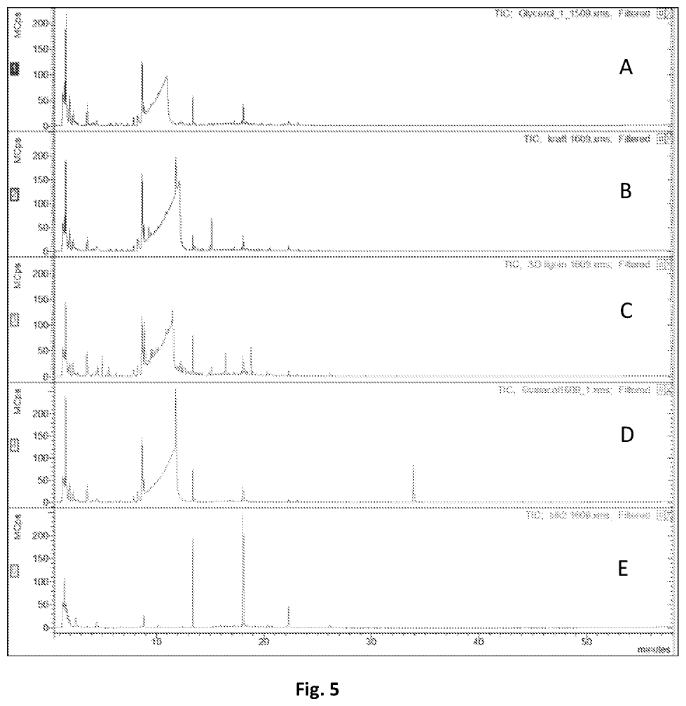

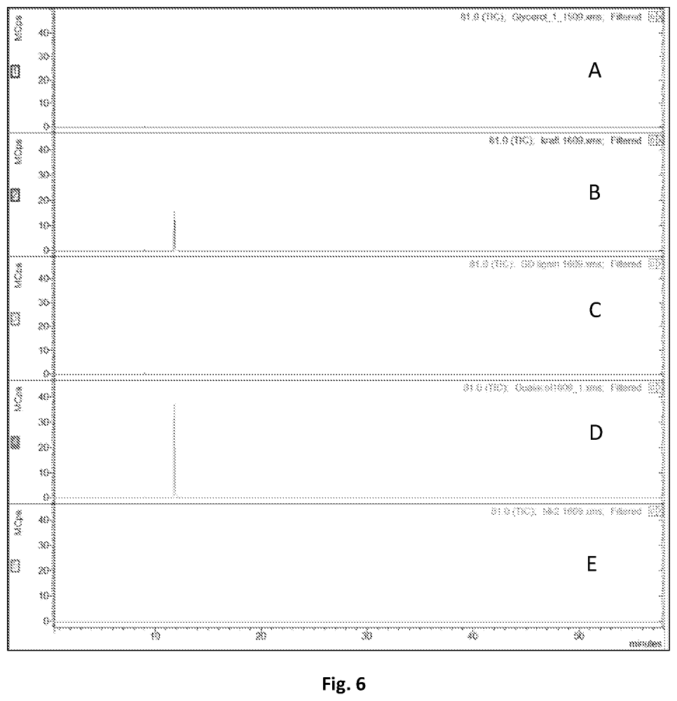

In an embodiment, commercial lignin and lignin of the present disclosure were qualitatively analysed using headspace-solid phase microextraction with gas chromatography coupled to mass spectrometry (HS-SPME-GC-MS). Guaiacol—one of the volatile compounds responsible for the strong smoky and woody odour of lignin—was only detected in the commercial lignin sample (FIG. 5 and FIG. 6), thus reinforcing the differences in terms of odour profile between the lignin in the present disclosure and the commercial alkali lignin.

### Example 1

In an embodiment, a lignin-based coating comprising the alkaline lignin of the present disclosure, and its subsequent application on a substrate via spray-up and solid-bar techniques was performed.

In an embodiment, the lignin type used for preparing lignin coatings was the alkaline lignin of the present disclosure. The glycol may comprise different types, such as glycerol, ethylene glycol, propylene glycol, 1-4 butanediol, or other polyols. More preferably, the current formulation for spray-up application is based on ethylene glycol. In an embodiment, additionally, the solvent for lignin dissolution comprises ammonia with concentrations between 0.4-0.6 M, more preferably 0.5 M. Table 7 below shows the suggested amounts range of compounds to develop lignin-based coatings based on a one-pot preparation and for application via spray-up.

TABLE 7
Weight percentage range of components in lignin-based coating
formulation using spray-up application.

| Lignin of the present disclosure | | |
|---|---|---|
| (wt %) | Glycol (wt %) | NH₄OH (wt %) |
| 10-17 | 17-20 | 65-70 |
| 17 | 17 | 66 |

More preferably, the quantity of lignin is 17 wt %, the glycol content is 17 wt % and the ammonia solution is 66 wt %.

In an embodiment, the coating mixture is prepared as follows: start pouring the ammonia solution first and then incorporate the oven dried lignin during constant stirring until total dissolution. Then incorporate the glycol in continuous stirring for 1-2 minutes. This initial mixing could be carried out at room temperature. Then, turn on the heater maintaining the stirring of the mixture at 50° C. The sample should be homogeneous without particle aggregates after mixing, and if it is not homogeneous, increase the mixing time and stirring speed. Finally, remove the magnetic stirrer and leave the sample to cool down to room temperature. At this moment, the coating mixture is ready to be applied via spray-up. The preferable viscosity range for application at 20° C. is between 600-1000 mPa·s.

In an embodiment, different layers of lignin-based coating comprising the oven dried lignin of the present disclosure are applied with each layer being allowed to dry for about 20 minutes at room temperature or put dried in an oven for about 5 minutes at 105° C. For a better adhesion between layers, the layers should not be completely dried.

### Example 2

In an embodiment, the coating formulation for solid bar application was prepared. The lignin type used is the oven dried lignin as described in the present disclosure. The glycol may comprise different types, glycerol, ethylene glycol, propylene glycol, 1-4 butanediol, and other polyols. More preferably, the current formulation for solid bar application is based on food-grade propylene glycol. Additionally, a compound namely polyethylene glycol sorbitan monolaurate (PEGSM) is used in the formulation for diverse purposes; for particles dispersion and as plasticizing agent in ranges between 2-10 wt % of the formulation. The solvent for lignin dissolution comprises ammonia with concentrations between 0.4-0.6 M, more preferably 0.5 M. Table 8 below shows the suggested weight percentage range of compounds to develop lignin-based coatings based on a one-pot preparation and for application via solid bar.

TABLE 8
Weight percentage range of components in lignin-based coating
formulation using solid bar application.

| Lignin of the present disclosure | Glycol | PEGSM | NH₄OH |
|---|---|---|---|
| (wt %) | (wt %) | (wt %) | (wt %) |
| 8-12 | 10-14 | 2-10 | 64-79 |
| 8 | 12 | 5 | 75 |

More preferably, quantities of lignin are 8 wt %, glycol is 12 wt %, PEGSM is 5 wt % and ammonia solution to complete the remaining 100 wt % of the formulation.

In an embodiment, the lignin-based coating formulation comprising the lignin of the present disclosure is prepared as follows: start pouring the ammonia solution and then incorporate the oven-dried lignin during constant stirring until total dissolution, then incorporate the glycol, followed by the addition of the PEGSM. This initial mixing could be carried out at room temperature. Then, turn on the heater maintaining the stirring of the mixture until 120° C. When the temperature reaches 120±3° C. leave the mixture until the mass loss reaches 60-65%. The preferable viscosity for solid bar application depends on the coating temperature; For applications at a temperature of 20° C., viscosities between 1500-2500 mPa·s are preferred, however, coatings with viscosities between 3000-8000 mPa·s may be uniformly applied at room temperature. The sample is preferably homogeneous without particle aggregates after mixing, and if it is not homogeneous, mixing time and stirring speed may be increased.

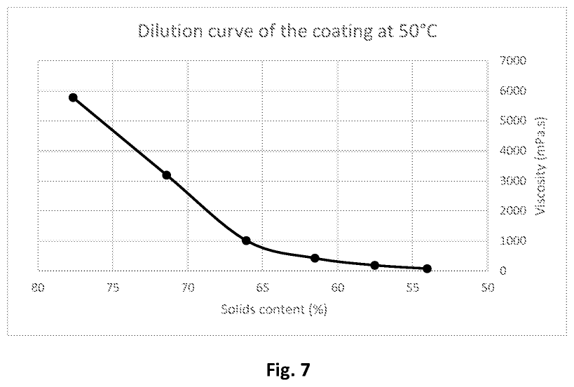

In an embodiment, the dilution curve of the original sample (FIG. 7) was prepared with the sample having a solvent content between 10-20% in weight after the solvent evaporation process. For example, a lignin-based coating formulation with 8% of lignin of the present disclosure, 12% of propylene glycol, 10% of PEGSM and 70% of ammonia solution was dried first at 120° C. to achieve between 54-78% of solids content. Thereafter the coating was diluted with addition of distilled water as presented in Table 8 below. The viscosity measurements were carried out in a rotational viscometer with spindle number 4, with 40-60% of rpm and the values were obtained after 20 seconds of rotation. This measurement was carried out at 50° C. (Table 8).

TABLE 8
Viscosity measurements of the coating
composition of the present disclosure.

| | Solids | Viscosity (mPa · s) |
|---|---|---|
| Cumulative H₂O added | (wt %) | at 50° C. |
| 0 | 78 | 5775 |
| 5 | 71 | 3194 |
| 10 | 66 | 1012 |
| 15 | 62 | 426 |
| 20 | 58 | 191 |
| 25 | 54 | 78 |

As shown in FIG. 7, the dilution of the lignin-based coating presents values between 62-66 wt % of solids content with appropriate viscosities to carry out the application with solid bar at 50° C. For coatings applied via solid bar, at room temperature (20° C.), the range of solids between 54-56 wt % is preferable. For coatings applied via spray-up, at room temperature (20° C.), the solids content is preferably between 50-60 wt %. As the mixture reaches the room temperature, its viscosity increases, so the properties are established to the desired application temperature.

In an embodiment, to carry out an adequate coating application, the substrate is flat and even, along its surface, and is supported on a solid and static surface. The substrate may be rough, smooth or porous and the viscosity of the coating may be adjusted according to those features. It is preferable to use a coater machine equipped with blade or bar applicators. The temperature of application may for example be performed from 20° C. to 50° C. The coating is preferably applied with bar coater between 25° C. to 30° C.

In an embodiment, after the lignin-based coating is applied onto the target surface, it is preferable to force the system to reticulate at high temperature. This process removes the residual solvent in the formulation, increasing the solid content of the coating resulting in the waterproof effect. This stage is of utmost importance to obtain durable and water-repellent surfaces. After that, the material behaves as a crosslinked thermosetting polymer. The conditions for post-curing this class of coatings comprise a convection oven capable to maintain temperatures between 100-200° C. for periods from 30 minutes to 200 minutes. More preferably, temperatures between 100-110° C. for 100-120 minutes are suggested for a standard 30 μm-thick coating.

In an embodiment, the substrate may be hydrophilic cellulose-based surfaces, such as non-treated papers, cardboard, fibreboard, particleboard, medium density fibreboards and solid wood substrates. More preferably, a paper surface for applying the waterproofing lignin-based coating comprising the lignin of the present disclosure.

In an embodiment, the said lignin-based coating applied onto paper, via solid bar, presented Cobb test values below 10 g/m² for coatings above 40 μm of wet thickness.

### Example 3

In an embodiment, a lignin-based thermoplastic polymer was prepared using the lignin of the present disclosure.

In an embodiment, grafting of caprolactone onto the lignin of the present disclosure was performed.

In an embodiment, the lignin type used is the lignin obtained from the spray drying process of the present disclosure. This lignin could be used in this process with or without acetylation treatment. The monomer precursor used is ϵ-caprolactone. The grafting may be controlled by the extent of the molar ratio between the total hydroxyl groups in the lignin structure and the molar weight of ϵ-caprolactone. To simplify this procedure, in this text the formulation is referred to mass ratio between compounds. The current process does not require the use of any solvent when the mass ratio of the compounds ϵ-caprolactone/lignin≥4. For lower mass ratios, the addition of xylene or toluene as solvents are employed with the aid of a reflux condenser during the process. As catalysts, different metal-based compounds are appropriate as indicated: Tin (II) 2-ethylhexanoate (stannous octoate), dibutyl tin dilaurate, n-butyl titanate (nTi). The recommended process is based on a ϵ-caprolactone/lignin mass ratio of 6-10 and the use of n-butyl titanate as catalyst without solvents and nitrogen protection (Table 9).

TABLE 9
Preferable amounts for caprolactone grafting.

| Lignin of the | | | | |
|---|---|---|---|---|
| present | Caprolactone | Catalyst n-Ti | Solvent | Fillers |
| disclosure (wt %) | (wt %) | (wt %) | (wt %) | (wt %) |
| 5-50 | 50-93 | 0.1-3 | 0-70 | 0-30 |
| 25.3 | 74.4 | 0.3 | 0 | 0 |

In an embodiment, weigh the amount of caprolactone, then slowly incorporate the lignin of the present disclosure with constant stirring until total dissolution. The lignin described in the present disclosure dissolves easily in caprolactone. Subsequently, increase the process temperature to 130° C. After a certain time, specifically for this example 3-4 hours, maintain the process until an increase of the viscosity in the mixture is observed. At this moment, pour the material on a flat surface and wash with methanol the solid. Depending on the process, amounts of reagents and lignin conditions, the reaction time could take between 2 and 20 hours. Finally, dry the thermoplastic in a vacuum oven to evaporate the organic solvent. To prepare the thermoplastic particles, the material may be ball-milled to form a lignin-caprolactone powder (LCL). In the current embodiment the amounts of caprolactone monomer, lignin and catalyst are 74.4%, 25.3% and 0.3 wt %, respectively.

In this stage, the LCL powder is mixed with pristine polycaprolactone pellets (PCL). The molecular weight of the PCL could be between 50000-80000 g/mol. The mixture ratio depends on the desired properties, and, for this purpose, it is suggested to have a mass ratio of PCL/LCL between 0.5-4 and preferably a PCL/LCL mass ratio of 2.

The mixing process is preferably performed in an equipment appropriate for such purpose a torque rheometer, Banbury mixer and/or twin extruders capable to maintain a shear force at temperatures between 100° C.-200° C.

In an embodiment, a thermoplastic material with a PCL/LCL mass ratio of 1, presented a tensile strength of 6.1 Mpa and an elastic modulus of 670 Mpa.

### Example 4

In an embodiment, lignin-based thermosetting polymers were prepared. The lignin type used in this development was lignin obtained from the spray drying process as described in the present disclosure. An aqueous ammonia solution of 0.5 M is utilized in this process to dissolve the lignin properly before its mixing with the other elements of the formulation. For this purpose, polyethylene and propylene glycols, in combination, or separately, are preferable. The preferable crosslinking agents for this type of polymers are citric acid, sebacic acid and itaconic acid. Citric acid is recommended as crosslinker agent.

This process does not require catalyst, however, if the reaction advances slowly the use of n-butyl titanate is recommended in catalytic amounts. Other fillers such as lignin, cellulose, natural fibres, bagasse, wood powder, silica, calcium carbonate, aluminium trihydroxide, montmorillonites and other mineral fillers may be used as reinforcing phases or for rheological purposes. The use of paraffin, Carnauba or Candelilla wax are incorporated in minimal amounts to reduce the stickiness of the resulting material, if necessary (Table 10).

TABLE 10
Preferable amounts for the thermosetting polymer formulation.

| Lignin of | | | | | | |
|---|---|---|---|---|---|---|
| the present | | | Cross- | | | |
| disclosure | Glycol | NH₄OH | linker | Fillers | Catalyst | Wax |
| (wt %) | (wt %) | (wt %) | (wt %) | (wt %) | (wt %) | (wt %) |
| 6-10 | 20-25 | 35-40 | 20-25 | 0-30 | 0.2-1 | 0.5-0.8 |
| 8 | 22 | 38 | 23 | 8 | 0.4 | 0.6 |

In an embodiment, the reaction process comprises melt condensation and post-curing. The first stage is carried out in a reactor vessel. First, the lignin is incorporated in the ammonia solution with continuous stirring at room temperature (23° C.). Then incorporate the glycol maintaining the stirring for approximately 1 hour. Thereafter, incorporate de citric acid slowly letting the components to blend for about 1 hour at 140° C. with special attention in water removal produced by the ammonia solution and during the esterification. Then, incorporate the catalyst into the mix. After the catalyst addition, the reaction normally occurs between 30 to 90 minutes.

In an embodiment, to observe the progress of the reaction, it is preferable to measure the acid value of the polymer. This property indicates that the acid groups reacted which results in a decreasing of its value. Acid values below 30 mg KOH/g are indicated to stop the reaction. If other compounds such as plasticizers, fillers and additives are added to the formulation, the reaction may take several hours, therefore acid value is preferably always controlled.

This class of materials do not melt as compared to their thermoplastic counterparts. As the gel time occurs, the polymer builds a rubber-like structure with an elastic behaviour dependent on the glycol type and the crosslinker content. The possibility of processing these materials is via casting before they reach the gel point.

The conditions for post-curing this class of polymers comprise a convection oven capable to maintain temperatures between 80 to 150° C. for periods from 1 hour to several days. Temperatures between 120 to 140° C. during periods between 6-8 hours are preferable.

Furthermore, where the claims recite a composition, it is to be understood that methods of using the composition for any of the purposes disclosed herein are included, and methods of making the composition according to any of the methods of making disclosed herein or other methods known in the art are included, unless otherwise indicated or unless it would be evident to one of ordinary skill in the art that a contradiction or inconsistency would arise.

Where ranges are given, endpoints are included. Furthermore, it is to be understood that unless otherwise indicated or otherwise evident from the context and/or the understanding of one of ordinary skill in the art, values that are expressed as ranges can assume any specific value within the stated ranges in different embodiments of the invention, to the tenth of the unit of the lower limit of the range, unless the context clearly dictates otherwise. It is also to be understood that unless otherwise indicated or otherwise evident from the context and/or the understanding of one of ordinary skill in the art, values expressed as ranges can assume any subrange within the given range, wherein the endpoints of the subrange are expressed to the same degree of accuracy as the tenth of the unit of the lower limit of the range.

The disclosure should not be seen in any way restricted to the embodiments described and a person with ordinary skill in the art will foresee many possibilities to modifications thereof.

The above described embodiments are combinable.

The following claims further set out particular embodiments of the disclosure.

1. A lignin comprising a light-brown colour, wherein the colour is at least L*=45, a*=6, b*=16 scales, measured by the CIELAB system, wherein guaiacol is absent in the lignin odour profile and wherein lignin has a sweet and woody odour, preferably with notes of paper wood and wooden pencil.

2. The lignin according to claim 1 wherein the lignin is obtainable from sugarcane bagasse.

3. The lignin according to claim 1 wherein the lignin is obtained by spray dryer.

4. The lignin according to claim 1 wherein the colour is at least L*=60.3, a*=6.1, b*=19.1 for a lignin obtained by spray dryer or is at least L*=48.4, a*=10.0, b*=20.3 scales for a lignin obtained by oven dryer.

5. The lignin according to claim 1 wherein the lignin particle size ranges from 0.3-280 μm, preferably with a D90 ranging from 50-60 μm; more preferably from 51.6-57.2 μm.

6. The lignin according to claim 1 wherein the lignin particle size ranges from 5-160 μm, preferably from 5-40 μm.

7. The lignin according to claim 1 comprising ultraviolet light absorbance activity ranging from 2-12, measured at the global solar irradiance in the UV wavelength ranging from 290-400 nm.

8. The lignin according to claim 1 wherein the degree of purity of the lignin is at least 85-90%, preferably more than 95%; more preferably more than 99%.

9. (canceled)

10. A lignin composition comprising a lignin according to claim 1 and at least one component of the following list: a hydroxyl precursor, a further polymer, a surfactant, or mixtures thereof.

11. The lignin composition according to claim 10 wherein the composition is a coating composition, preferably a packaging coating composition.

12. The lignin composition according to claim 10 wherein the hydroxyl precursor is selected from: a glycol; preferably ethylene glycol, a propylene glycol; glycerol, 1-4 butanediol, polyol, or mixtures thereof.

13. The lignin composition according to claim 10 wherein the surfactant is polyethylene glycol sorbitan monolaurate (PEGSM) or sorbitane monooleate, or mixtures thereof.

14. The lignin composition according to claim 10 further comprising ammonium hydroxide.

15. The lignin composition according to claim 10 comprising
7 to 17 wt % of lignin;
9 to 20 wt % of glycol;
0 to 10 wt % of PEGSM; and
ammonium hydroxide to complete 100 wt %.

16. The lignin composition according to claim 10 wherein the hydroxyl precursor is selected from a list consisting of: propylene glycol, glycerol, 1-4 butanediol, polyol, or mixtures thereof.

17. (canceled)

18. (canceled)

19. (canceled)

20. (canceled)

21. (canceled)

22. (canceled)

23. (canceled)

24. A method of preparing the lignin according to claim 1 from a sugarcane bagasse (SCB) comprising the step of:
pre-treatment of SCB using an alkaline solution, preferably soda, in order to obtain a black liquor;
acid precipitation of the black liquor obtained in the previous step and collection of the precipitate to obtain lignin;
drying the collected precipitate and optionally milling the dried lignin;
optionally the drying process is spray drying.

25. The method according to claim 24 wherein:
the spray drying step is performed comprising 65% aspirator rate, flow height 40-45 mm, pump speed 12% and inlet temperature 160° C.;
wherein the time of the precipitation stage ranges from 2-20 minutes, preferably from 5-10 minutes;
the drying is a spray drying or oven drying; and
the degree of purity of the obtained lignin is at least 85-90%, preferably more than 95%; more preferably more than 99%.

26. The method according to claim 24 wherein the alkaline solution is sodium hydroxide, preferably 2-6 wt % sodium hydroxide, more preferably 2-3 wt % sodium hydroxide.

27. The method according to claim 24 wherein the precipitation agent is H₂SO₄, wherein the amount of H₂SO₄ ranges from 10-50% (v/w), preferably from 20-35% (v/w), more preferably 30% (v/w).

28. The method according to claim 24 wherein the temperature of the precipitation stage ranges from 18-25° C., preferably from 20-22° C.

29. (canceled)

30. (canceled)

31. (canceled)
